(19) United States
(12) Patent Application Publication
(10) Pub. No.: US 2005/0046153 A1
(43) Pub. Date: Mar. 3, 2005

(54) Airbag inflator mounting apparatus and method

(76) Inventors: Timothy A. DePottey, Flint, MI (US); Samuel Olar, Sterling Heights, MI (US); Michael Zimmerman, Waterford, MI (US)

Correspondence Address: Sally J. Brown;AUTOLIV ASP, INC., 3350 Airport Road, Ogden, UT, 84405, US

(21) Appl. No.: 10/649,481

(22) Filed: Aug. 27, 2003

(51) Int. Cl. B60R 21/16

(52) U.S. Cl. 280/728.2

(57) ABSTRACT

An airbag module mounting device that facilitates installation of an inflator in a vehicle. The mounting device has a mounting plate and retention devices extending from the mounting plate. The retention devices may be clips that flex to receive an outer edge of the inflator flange, and snap into engagement with the flange to grip the flange against the mounting plate to securely retain the inflator against the mounting plate. Alternatively, the retention devices may be snaps that extend through holes in the inflator flange. The retention devices may also include rigid retainers that slidably receive the inflator flange and retention arms that snap into position to lock the flange in place.

### BACKGROUND OF THE INVENTION

1. Field of the Invention

The present invention relates to systems and methods for protecting vehicle occupants from injury. More specifically, the present invention relates to an airbag inflator mounting apparatus that simplifies the assembly of an airbag module.

2. Description of Related Art

The inclusion of inflatable safety restraint devices, or airbags, is now a legal requirement for many new vehicles. Airbags are typically installed in the steering wheel and in the dashboard on the passenger side of a car. Additionally, airbags may be installed to inflate beside the passenger to provide side impact protection, in front of the knees to protect the knees from impact, or at other strategic locations.

In the event of an accident, a sensor system within the vehicle senses an impact situation and triggers the ignition of an inflator. Inflation gases from the inflator fill the airbag cushions, which immediately inflate to protect the driver and/or passengers from impact against the interior surfaces of the vehicle. During normal vehicle operation, airbags are typically stowed behind covers to protect them from tampering and provide a more attractive interior facade for the vehicle.

Typically, the inflator is securely mounted within the vehicle in such a manner that the exiting gases enter the cushion, either directly or through a conduit called a “gas guide.” Many types of inflators are subject to strong thrust forces from the exiting inflation gas and must be securely attached to the mounting device. As a result, an inflator is typically mounted through the use of various pieces hardware such as brackets, mechanical fasteners, and/or other retention devices.

Unfortunately, the assembly of an inflator and a mounting device, according to these methods, increases the total number of manufacturing steps in assembling an airbag module. Often, an installer must perform a number of actions such as picking up fasteners, gripping the structure to which the inflator is to be attached, aligning the inflator with the structure, aligning the fasteners with the inflator, and applying the fasteners. In the case of threaded fasteners such as bolts, the fasteners must be rotated into place. Consequently, multiple steps must be performed and automation is more difficult to use. These additional manufacturing steps increase the costs of manufacturing an airbag module.

Furthermore, the necessary mounting hardware adds to the part count of the airbag module, thereby adding significantly to the overall module cost. Additionally, each part and/or manufacturing step adds an additional point of failure that may decrease the reliability of the airbag module and increase incidence of repair and/or reworking. Furthermore, some inflator attachment schemes are limited to only one specific inflator type, and thus cannot be used for multiple airbag module configurations. Thus, additional production capacity, inventory, and the like must be maintained to provide for the attachment of multiple inflator types.

### SUMMARY OF THE INVENTION

The apparatus and method of the present invention have been developed in response to the present state of the art, and in particular, in response to the problems and needs in the art that have not yet been fully solved by currently available airbag modules. Thus, it is an overall objective of the present invention to provide an airbag module and associated assembly method that remedies the shortcomings of the prior art.

To achieve the foregoing objective, and in accordance with the invention as embodied and broadly described herein in one embodiment, an airbag module includes a cushion, an inflator, and an enhanced mounting device that facilitates attachment of the inflator to the vehicle. The inflator has a flange that further facilitates the attachment.

The mounting device comprises a mounting plate and a plurality of retention devices that engage the flange of the inflator to hold the inflator securely in place against the mounting plate. The mounting device has a plurality of holes in its periphery so that the mounting device may be installed in a vehicle. In the middle of the mounting device is a recessed area that is the mounting plate. The mounting plate comprises a planar surface that the flange of the inflator is mounted against.

In this embodiment, the retention devices comprise clips. The clips are integrally formed with the mounting plate and each clip comprises a shank extending from the mounting plate and a head that extends over the mounting plate and has an angled outer surface. The clip secures the flange of the inflator by flexing from a natural configuration to allow the inflator to contact the mounting plate and then move back towards the natural configuration of the device. The clip flexes when the flange engages the angled head of the clip, forcing the shank to bend and move the head out of the way.

When the flange passes the head, the shank flexes back towards its natural configuration, allowing the head to overlap the flange. Because the inner surface of the clip is parallel with the mounting plate or angled from the shank toward the mounting plate, the clip resists urging of the inflator from the mounting device. In this embodiment, the shank of the clip is the same height as the flange, so the head of the clip grips the flange and overlaps the edge of the flange.

In addition, the other clips are spaced about the mounting plate so that the flange of the inflator when engaged with the mounting plate barely fits between the shanks of the clips. The shanks of the inflator prevent the inflator from moving on the mounting plate, while the heads prevent the inflator from being removed from the mounting device.

In an alternative embodiment, the retention devices are snaps, which work similarly to clips, but snaps comprise a plurality of shanks and heads arranged in a circle. Like clips, the outer surface of the heads of a snap are angled toward the mounting plate away from the center of the circle and the heads extend out over the mounting plate. Another difference between snaps and clips is that snaps engage holes in the flange of an inflator. As the hole in the flange is pressed against the heads of the snap, the shanks flex toward the center of the circle, thus moving the heads out of the way of the flange. Like snaps, once the flange passes the heads, the heads flex toward their natural configuration to either grip or overlap the flange.

In another alternative embodiment, the mounting device is a generally planar surface without a recess. Like previous embodiments, the mounting plate is still the area in the middle of the mounting device; however, the retention devices comprise rigid retainers and retention arms. The rigid retainers do not flex, but rather overlap the flange of the inflator to hold the flange against the mounting plate. The rigid retainers have a shank that extends from the mounting plate and a head that extends over the mounting plate. A flange of an inflator is slid under the head of the rigid retainer.

In this embodiment, two rigid retainers are arranged parallel to each other and work with retention arms to secure the inflator against the mounting plate. The retention arms are simple tab structures that extend from the shanks of the rigid retainers. The retention arms work by flexing out of the way of the flange as it is slid under the rigid retainers and once the flange moves past, the retention arms flex back toward their natural configuration to prevent the inflator from being removed from the mounting device. A mounting stop, which may be a piece of material extending from the mounting plate, prevents the inflator from sliding out from under the rigid retainers on the side opposite the retention arms.

In each of the embodiments above, an inflatable cushion may be mounted on the inflator mounting assembly. The inflatable cushion may be a standard cushion well known in the art with an inlet to receive gas from the inflator. The inflatable cushion may be folded or rolled for mounting on the inflator mounting assembly. With the major components assembled, the airbag module may then be mounted in the vehicle in a variety of locations.

As is discussed above, assembly of the inflator and the mounting device depends on the configuration of the mounting device and what kinds of retention devices are included with the mounting plate. The methods of assembly generally comprise the steps of aligning the inflator with the retention devices and pressing or sliding the inflator into place on the mounting plate.

Through the use of the airbag modules and associated manufacturing methods of the present invention, airbags may be produced in a more efficient and cost-effective manner. Furthermore, the overall reliability of airbag modules may be improved by reducing the points of possible failure. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side elevation view of an airbag module within the scope of the invention mounted as a passenger side airbag within the dashboard of a vehicle;

FIG. 2 is a perspective view of the mounting device and inflator of FIG. 1;

FIG. 3 is a perspective view of an alternative embodiment a mounting device and an inflator; and

FIG. 4 is a perspective view of a mounting device and an inflator according to another alternative embodiment of the invention.

### DETAILED DESCRIPTION OF THE PREFERRED EMBODIMENTS

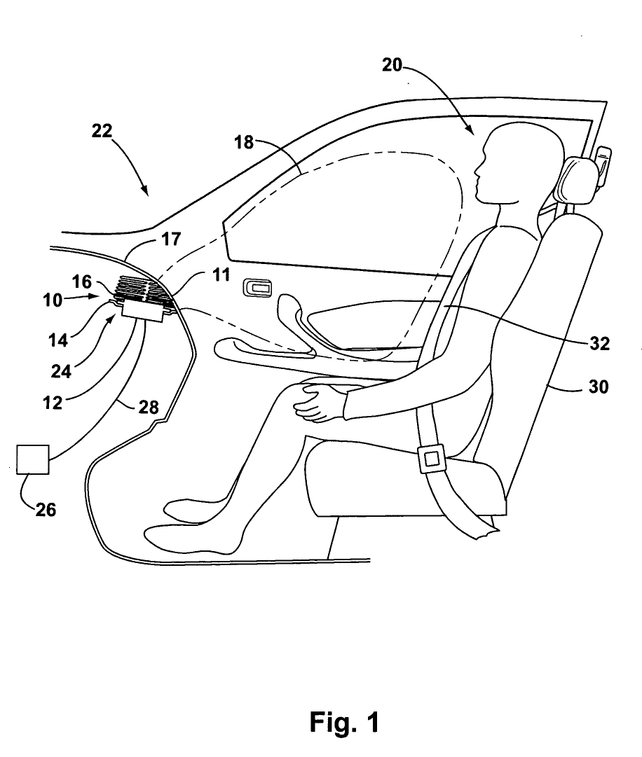

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 4, is not intended to limit the scope of the invention, as claimed, but is merely representative of presently preferred embodiments of the invention.

For this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “attached directly to” refers to a form of attachment by which the attached items are either in direct contact, or are only separated by a single fastener, adhesive, or other attachment mechanism. The term “abutting” refers to items that are in direct physical contact with each other, although the items may not be attached together. The term “grip” refers to items that are in direct physical contact with each other, wherein one item holds the other firmly. The term “overlap” refers to items that are proximate to each other, wherein one extends over and covers a part of the other, but not necessarily in contact with each other.

Referring to FIG. 1, a side elevation view shows an airbag module 10 within the scope of the invention, mounted within a passenger side airbag mounting port 11. The airbag module 10 is depicted in its fully assembled form comprising an inflator 12, a mounting device 14, and an inflatable cushion 16. The passenger side airbag mounting port 11 is disposed within a dashboard 17. The inflatable cushion 16 when inflated 18 is of a type that protects the upper body of an occupant 20 when the vehicle 22 is involved in a front impact. However, those of skill in the art will recognize that the present invention is equally applicable to other types of airbags, such as knee bolsters, overhead airbags, inflatable curtains, inflatable structural stiffeners, and other applications where an inflator is used.

The inflator 12 and the mounting device 14 when combined are called an inflator mounting assembly 24. The inflatable cushion 16 may be mounted on the inflator mounting assembly 24 before or after the inflator mounting assembly 24 has been installed in a vehicle 22. When the inflatable cushion 16 is assembled with the inflator mounting assembly 24, the inlet (not shown) of the inflatable cushion 16 is positioned to receive gas from the inflator 12.

During installation in the vehicle 22, the inflator 12 is connected to the controller 26 by the controller connector 28. The controller 26 collects data from the crash sensors (not shown) to determine when the inflator 12 should be actuated, thereby inflating the inflatable cushion 16. The airbag module 10, a seat 30, and a seatbelt 32 help to protect the occupant 20 from injury resulting from an impact.

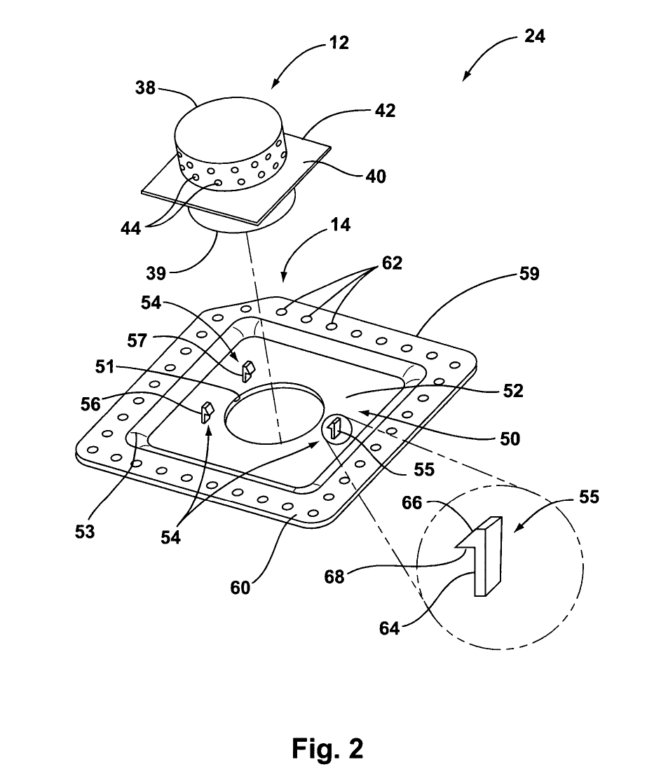

Referring to FIG. 2, a perspective view illustrates the mounting device 14 and inflator 12 of FIG. 1. The inflator 12 is generally tubular and comprises a top 38, a bottom 39, and a flange 40 extending outward between the top 38 and the bottom 39 of the inflator 12. The flange 40 of FIG. 2 is square, but may, in alternative embodiments, be replaced by a flange having a rounded shape some other polygonal shape, or a combination thereof. The flange 40 has an outer edge 42. The inflator 12 has inflation gas ports 44 located around the top 38 of the inflator 12.

The mounting device 14 comprises a mounting plate 50 having a hole 51 in which the bottom 39 of the inflator 12 is inserted and a planar surface 52, upon which the inflator 12 is held securely. The mounting plate 50 is disposed within a recess 53 and the mounting plate 50 also comprises three integrally formed retention devices 54 extend from the mounting plate 50. The retention devices 54 can include both rigid and flexible types. The retention devices 54 in this embodiment are a first clip 55, a second clip 56, and third clip 57. The first clip 55 is disposed opposite the second and third clips 56 and 57 on the mounting plate 50 and separated from the second and third clips 56, 57 by a distance equivalent to the width of the flange 40 of the inflator 12. A hole 51 is disposed between the first clip 55 and the second and third clips 56 and 57 on the mounting plate 50. The second and third clips 56 and 57 are positioned to grip the same side of the flange and are spaced apart by a distance approximately equal to the diameter of the hole 51.

In addition to the mounting plate 50 and recess 53, the mounting device 14 comprises an outer rim 59, which is generally rectangular in shape. The outer rim 59 surrounds the periphery 60. The periphery 60 of the mounting device 14 has mounting holes 62 to facilitate mounting the airbag module 10 in the vehicle 22.

Each of the clips 55, 56, and 57 comprises two parts: a shank 64 and a head 66. The shank 64 extends from the mounting plate 50 and the head 66 is disposed at the outer end of the shank 64. The head 66 is angled and extends slightly off the shank 64. The exposed bottom surface of the head 66 is a retention surface 68 that extends generally parallel to the planar surface 52. Each retention surface 68 grips the outer edge 42 of the flange 40 of the inflator 12 against the mounting plate 50 to securely hold the inflator 12 in place. The clips 55, 56, and 57 also prevent the inflator 12 from rotating when gripped by the mounting device 50.

The mounting device 14 and the inflator 12 are assembled by first aligning the outer edge 42 of the flange 40 of the inflator 12 with the clips 55, 56, and 57 and the bottom 39 of the inflator 12 with the hole 51 in the mounting device 14. Then the inflator 12 is pressed into the mounting plate 14 until the inflator 12 snaps into place against the mounting plate 50. In snapping the inflator 12 into place, the clips 55, 56 and 57 flex outward to receive the flange 40 and then return back toward their natural configurations to grip the outer edge 42 of the flange 40 of the inflator 12. In gripping the outer edge 42, the head 66 extends over the outer edge 42 to contact the flange 40. Note, that an outer edge of a flange may be a variety of shapes and configurations. The term “snaps” as used in this application refers to a retention device flexing from a natural configuration to receive the item in response to motion of the item and then moving back towards the natural configuration to grip the item.

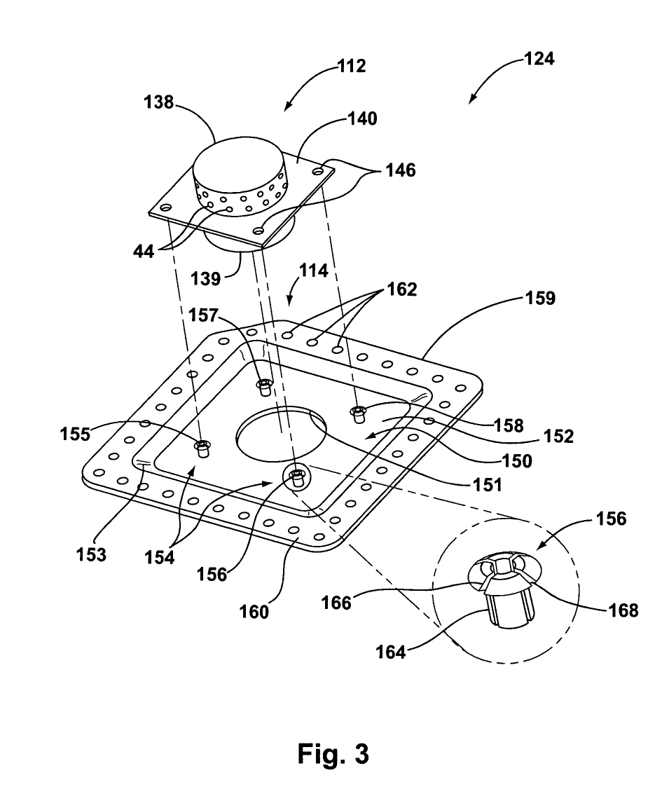

Referring to FIG. 3, a perspective view illustrates an alternative embodiment of an inflator 112 and a mounting device 114. The inflator 112 and the mounting device 114 may be combined to form an inflator mounting assembly 124 that may also be installed in a vehicle (not shown) similarly to the mounting assembly 24 of FIG. 1. The inflator 112 comprises a top 138 and a bottom 139 with a flange 140 around the middle of the inflator. Around the top 138 are the inflation gas ports 44. The flange 140 in this embodiment is not solid but has four holes 146. Otherwise, the inflator 112 is generally similar to the inflator 12 of the previous embodiment.

The mounting device 114 comprises a mounting plate 150 with a hole 151 in the middle of the mounting plate 150 large enough to allow the bottom 139 of the inflator 112 to fit into the hole 151. The mounting plate 150 further comprises a planar surface 152. The mounting plate 150 is disposed within a recess 153 of the mounting device 114. The mounting device 114 also comprises four retention devices 154. The retention devices 154 are a first snap 155, a second snap 156, a third snap 157, and a fourth snap 158. In addition to the mounting plate 150, the mounting device 114 further comprises an outer rim 159 that is generally rectangular and a periphery 160 having a plurality of mounting holes 162.

Each of the snaps 155, 156, 157, and 158 has a shank 164 with the shape of a circle radially split into sections with a corresponding head 166 sloping away from a center of the circle. The exposed bottom surface of the head 166 is a retention surface 168. The snaps 155, 156, 157, and 158 function by flexing in the shanks 164 from a natural configuration toward the center of the circle, when the holes 146 of the flange 140 of the inflator 112 are pressed over each snap 155, 156, 157, and 158. Once the top of the flange 140 passes the heads 166 of the snaps 155, 156, 157, and 158, the shanks 166 of snaps 155, 156, 157, and 158 flex back toward the natural configuration and the retention surface 168 grips the flange 140 of the inflator 112 against the mounting plate 150.

Once the snaps 155, 156, 157, and 158 have gripped the flange 140 of the inflator 112, the snaps 155, 156, 157, and 158 resist nondestructive disassembly, which means that the inflator 112 cannot be urged from the mounting device 114 without damaging the snaps 155, 156, 157, and 158 or applying some type of additional implement to force each individual snap 155, 156, 157, and 158 to flex out of the way of the flange 140, to allow for disassembly.

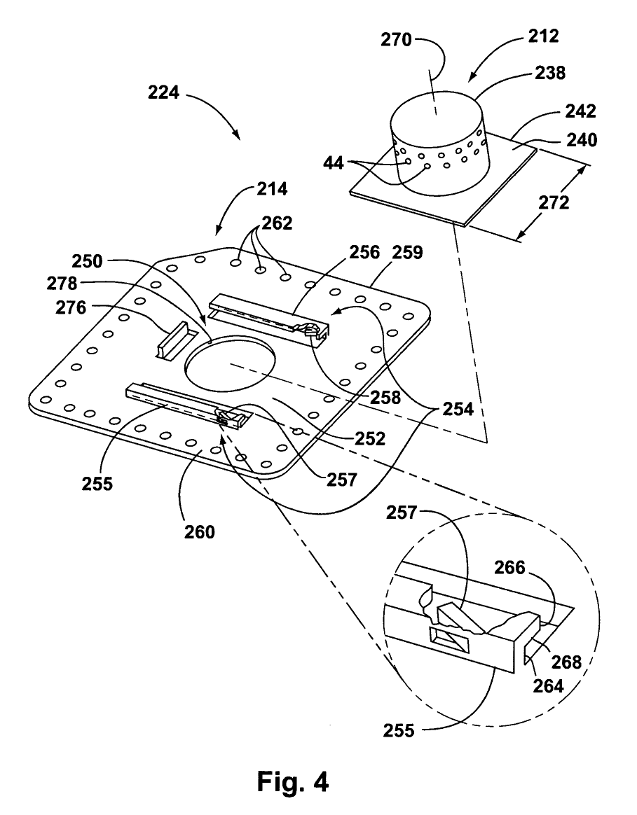

Referring to FIG. 4, a perspective view illustrates an inflator 212 and a mounting device 214 according to another alternative embodiment of the invention. The combination of the inflator 212 and the mounting device 214 provides an inflator mounting assembly 224. The inflator 212 is different from the other inflators 12 and 112 described above, because the inflator 212 comprises only a top 238, with inflation gas ports 44 radially disposed about the top 238, and a flange 240. The flange 240 is solid, square in shape, and comprises an outer edge 242.

The mounting device 214 comprises a mounting plate 250 having a planar surface 252. This embodiment is assembled differently than the embodiments described above. Accordingly, there is no recess in the mounting device 214 of this embodiment.

The retention devices 254 comprise a first rigid retainer 255, a second rigid retainer 256, a first retention arm 257, and a second retention arm 258. The outer rim 259 of the mounting device 214 is generally rectangular in shape. The periphery 260 is disposed just inside the outer rim 259. The periphery 259 comprises mounting holes 262 to facilitate installation of the inflator mounting assembly 224 in a vehicle and attachment of an airbag (not shown).

Each of the rigid retainers 255 and 256 comprises a retainer shank 264 extending from the mounting plate 214. A retainer head 266 extends from the outer end of the retainer shank 264. The exposed bottom surface of the retainer head 266 is a retention surface 268. The shanks 264 of the rigid retainers 255 and 256 are disposed opposite each other on the mounting plate 250 at a distance of approximately the flange 240 of the inflator 212.

Like the inflators 12, 112 of the previous embodiment, the inflator 212 may be of a type typically used in a driver's side, frontal impact airbag module. In a driver's side inflator, the height along the axis of symmetry is typically smaller than the width of the inflator. Hence, such inflators may have a disk-like shape. In the embodiment of FIG. 4, this concept is illustrated with greater clarity. A height of the inflator 212 along an axis of symmetry 270 of the inflator 212 is less than a width 272 of the inflator 212. Nevertheless, inflators of many different types and shapes may be used in conjunction with the present invention.

The retention arms 257 and 258 are simple tab structures cut from the shanks 264 of the rigid retainers 255, 256 such that the retention arms 257, 258 extend inward from the shanks 264 of the rigid retainers 255 and 256. The retention arms 257 and 258 are disposed opposite each other on one end of the mounting plate 250. The retention arms 257, 258 flex from a natural configuration out of the path of the flange 240 to allow the flange 240 to slide under the retention surfaces 268 of the rigid retainers 255 and 256. Once the flange 240 slides past the retention arms 257 and 258, the retention arms 257 and 258 and flex back toward the natural configuration.

The mounting stop 276 is disposed on the opposite side of the mounting plate 250 from the retention arms 257 and 258. The mounting stop 276 prevents the flange 240 from sliding out from underneath the retention surfaces 268 of the rigid retainers 255 and 256, toward the corresponding end of the mounting device 214. The mounting stop 276 cooperates with the retention arms 257 and 258 to hold the inflator 212 securely on the mounting plate 250 in a manner that will be described subsequently.

An access hole 278 is disposed in the middle of the mounting plate 250 to provide access to the adjacent end of the inflator 212 to permit installation of electrical connectors or the like after the inflator 212 and the mounting device 214 have been assembled. The access hole 278 is disposed between the rigid retainers 255 and 256 and between the mounting stop 276 and the retention arms 257 and 258.

The inflator 212 and the mounting device 214 are assembled by sliding the flange 240 of the inflator 212 under the retention surfaces 258 of the rigid retainers 255 and 256 and past the retention arms 257 and 258, resulting in deflection the retention arms 257 and 258 to a position parallel to or nearly parallel to the shanks 264. The flange 240 of the inflator 121 is able to slide until the flange 240 contacts the mounting stop 276 and the retention arms 257 and 258 are allowed to flex back toward the natural configuration of the retention arms 257 and 258, thus blocking withdrawal of the flange 240 along the opposite direction to secure the inflator 212.

It should also be noted that different retention devices may be used with this embodiment and assembly method. For example, a nub (not shown) extending from the mounting plate 250 may have a tapered leading surface and an upright, flat trailing surface. The nub would compress to allow the flange to pass over it and under the retention surfaces 268 of the rigid retainers 255 and 256. Once the flange 240 is pressed up against the mounting stop 276, the flange 240 of the inflator 212 would seat against the flat trailing surface of the nub to prevent withdrawal of the flange. Additionally, retention arms formed in the mounting plate 250 could be used instead of retention arms 257 and 258 formed in the shanks 264 of the rigid retainers 255 and 256.

Another possible embodiment of a mounting device uses a rigid retainer on one side of a mounting plate and snaps or clips on the opposite side of the mounting plate. The flange of the inflator is then slid at an angle between the retention surface of the rigid retainer and the mounting plate. The flange is then rotated toward the mounting plate until the flange engages the snaps or clips on the opposite side of the mounting plate to securely hold the inflator against the mounting device.

A further embodiment of a mounting device and inflator may include a mounting device wherein the retention devices comprise a rigid retention device and a nub. The rigid retention device in this embodiment has a shank and a head, wherein the shank extends from a mounting plate positioned on one side of an access hole in the mounting device. The head of the rigid retainer extends out over the mounting plate. The nub is disposed on the other side of the access hole opposite the rigid retention device on the mounting plate.

The inflator does not have flange but instead comprises a hole in the base of inflator that is shaped like the head of the rigid retainer and a recess that matches the size of the nub. The hole in the base of the inflator opens to a cavern extending in an arc within the base. The inflator is assembled with the mounting device by inserting the rigid retainer into the hole in the base and rotating the inflator. Rotating the inflator turns the head of the rigid retainer into the cavern, which places part of the inflator between the head and the mounting plate. The inflator is rotated until the nub is seated within the recess in the base of the inflator.

A separate embodiment of a mounting device and inflator comprises an inflator without a flange and a mounting device. The inflator has four recesses evenly spaced about the inflator, wherein each recess has a surface that is closest to a mounting plate of the mounting device when the inflator is mounted recesses, wherein the surface is parallel with or angled toward the middle of the inflator and the mounting plate. The mounting device comprises four retention devices each having a shank, wherein each shank has a length that is similar to the distance of the base to an outside lip of the surfaces of the recesses. The retention device also comprises an angled head extending from the shank over the mounting plate. The retention devices are disposed about the mounting plate so as to engage respective recesses in the inflator.

The inflator is actuated toward the mounting plate and engages the heads of the retention devices. As the inflator is urged toward the mounting plate the shanks flex away from the inflator, allowing the inflator to move past the heads. As the inflator contacts the mounting plate, the retention devices flex back toward their natural configuration. The heads enter the recesses to secure the inflator against the inflator.

Retention devices that are not integrally formed with the mounting plate may also be used with this method and apparatus. For example, separately formed clips having a head on either end of a shank could be snapped onto a flange of an inflator and onto a mounting plate of a mounting device. Similarly, a snap may have multiple shanks and heads at both ends of the shanks. Such a snap could be snapped into a hole in the flange of an inflator and into a hole in the mounting plate.

It should also be noted that the mounting device may be any shape. For example, the mounting device could be a square, an oval, or a circle. Additionally, the mounting plate may incorporate rubber seals to prevent the inflation gas from leaking between a mounting plate and an inflator, or between a mounting plate and a plenum chamber or other surrounding structure.

A mounting device with integral retention devices may be manufactured in a variety of ways, including stamping, machining, welding, casting, and injection molding. In addition, the mounting device may be made from other materials including various metals, metal alloys, composites, and plastics.

Stamping provides excellent material characteristics in grain structure and work hardening of a metal mounting device. However, metal mounting device may need to be annealed to relieve the internal stresses in the, in order for the retention devices to function properly.

An exemplary stamping process may first stamp a blank of the mounting device. Second, mounting holes may be formed in the blank. Third, a recess and mounting plate is formed in the mounting device. Fourth, the retention devices may be outlined and the heads of the retention devices shaped. Fifth, the heads are bent into position. Sixth, the shanks are bent up from the mounting plate completing the mounting device. Of course, steps may be combined or other steps added to form other features in the mounting device, such as additional holes, retention devices, or a mounting stop.

Investment casting and injection molding may also be used to form a mounting device. Injection molding of the mounting device may be used to make plastic and composite mounting devices. An injection molding apparatus may use a three-part mold comprising a back part and two front halves. The back would provide the detail for the bottom of the mounting device, mounting holes, access hole, and outer rim. The two front halves may move over the top of the back to close the mold. By moving over the top of the back part, clips or rigid retainers may be formed on the mounting plate in alignment with the movement of the mold. Other features may be added through further machining of the molded mounting device.

If a wax mounting device is formed by the injection molding process, the wax mounting device may then be subsequently used in an investment casting process. The wax mounting device is first repeatedly dipped in a ceramic slurry to build up a mold exterior. Once the mold exterior is adequately thick, the mold is placed in an oven to melt and remove the wax mounting device. Next, the mold may be filled with molten metal alloy and allowed to cool. Once cool, the mold is then broken away from the metal mounting device. Other features may then be added through further machining of the molded mounting device.

The inflator mounting assemblies 24, 124, and 224 of FIGS. 2, 3 and 4 are simply examples. The inflator design and module requirements may necessitate a wide variety of changes to the embodiments shown. Many other inflation assemblies may be created within the scope of the present invention by combining, isolating, or otherwise modifying the features depicted in the figures.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag module for protecting an occupant of a vehicle from impact, the airbag module comprising:
an inflator having a flange; and
a mounting device comprising a first retention device integrally formed with a mounting plate, wherein the first retention device snaps into engagement with the flange in response to motion of the flange toward the mounting plate to secure the flange in a manner that resists nondestructive disassembly.

2. The airbag module of claim 1, wherein the flange comprises an outer edge, wherein the first retention device overlaps the outer edge to grip the inflator.

3. The airbag module of claim 2, wherein the first retention device comprises a clip comprising a shank extending from the mounting plate and a head comprising a retention surface that contacts the flange proximate a straight portion of the outer edge, wherein the shank is deformable to permit flexure of the first retention device.

4. The airbag module of claim 1, wherein the first retention device comprises a snap comprising a shank extending from the mounting plate and a head comprising a retention surface that contacts the flange proximate a hole formed in the flange, wherein the shank is deformable to permit flexure of the first retention device.

5. The airbag module of claim 1, wherein the mounting device further comprises a second retention device disposed opposite the first retention device with respect to the mounting plate to permit installation of the flange generally between the first and second mounting devices.

6. The airbag module of claim 1, wherein the mounting device further comprises two rigid retainers disposed to slidably receive the inflator, wherein the first retention device acts to prevent nondestructive sliding removal of the inflator from the rigid retainers.

7. The airbag module of claim 6, wherein each of the rigid retainers comprises a retainer shank and a retainer head having a retainer surface generally facing the mounting plate to grip the flange against the mounting plate.

8. The airbag module of claim 1, wherein the mounting device comprises a periphery having one or more mounting holes to facilitate installation of the mounting device in a vehicle.

9. The airbag module of claim 1, wherein the mounting device comprises a recess in which the inflator is mounted.

10. The airbag module of claim 1, wherein the mounting device is shaped for use in a passenger side airbag mounting port.

11. The airbag module of claim 9, wherein the mounting device comprises an outer rim comprising a generally rectangular shape.

12. The airbag module of claim 9, wherein the inflator comprises an axis of symmetry, wherein the inflator is shorter along the axis of symmetry than a width of the inflator perpendicular to the axis of symmetry.

13. The airbag module of claim 1, further comprising an inflatable cushion having an inlet disposed to receive inflation gas from the inflator.

14. An inflator mounting assembly for an airbag module for protecting an occupant of a vehicle from impact, the inflator mounting assembly comprising:
an inflator having a flange; and
a mounting device comprising a mounting plate and a retention device integrally formed with the mounting plate, wherein the retention device comprises a retention surface disposed to contact the flange, wherein the retention device flexes from a natural configuration to receive the flange and moves back towards the natural configuration in response to insertion of the inflator to secure the flange against a planar surface of the mounting plate.

15. The inflator mounting assembly of claim 14, wherein the mounting device further comprises a second retention device disposed opposite the first mounting device with respect to the mounting plate to permit installation of the flange generally between the first and second mounting devices.

16. The inflator mounting assembly of claim 14, wherein the mounting device further comprises two rigid retainers disposed to slidably receive the inflator, wherein the first retention device acts to prevent nondestructive sliding removal of the inflator from the rigid retainers.

17. The inflator mounting assembly of claim 14, wherein the mounting device is shaped for use in a passenger side airbag mounting port.

18. The inflator mounting assembly of claim 14, wherein the inflator comprises an axis of symmetry, wherein the inflator is shorter along the axis of symmetry than a width of the inflator perpendicular to the axis of symmetry.

19. The inflator mounting assembly of claim 14, wherein the retention surface is disposed at an angle with respect to the planar surface such that urging withdrawal of the flange from the mounting plate does not induce flexure of the retention device from the natural configuration.

20. A mounting device for securing an inflator in a vehicle, the mounting device comprising:
a mounting plate comprising a planar surface on which the inflator contacts the mounting device; and
a plurality of retention devices integrally formed with the mounting plate and extending from the planar surface, wherein each of the retention devices snaps into engagement with the inflator in response to insertion of the inflator to secure the inflator in a manner that resists nondestructive disassembly.

21. The mounting device of claim 20, wherein each of the retention devices comprise a shank and a head having a retention surface generally facing the mounting plate to grip the inflator against the mounting plate.

22. The mounting device of claim 20, wherein each of the retention devices comprises a retention surface disposed at an angle with respect to the planar surface such that urging withdrawal of the inflator from the mounting plate does not induce flexure of the retention devices from the natural configuration.

23. The mounting device of claim 20, wherein the retention devices are disposed to permit installation of the inflator generally between the retention devices.

24. The mounting device of claim 20, wherein the mounting device further comprises two rigid retainers disposed to slidably receive the inflator, wherein each of the retention devices act to prevent nondestructive sliding removal of the inflator from the rigid retainers.

25. The mounting device of claim 20, wherein the mounting device comprises a periphery having one or more mounting holes to facilitate installation of the mounting device in a vehicle.

26. An airbag module for protecting an occupant of a vehicle from impact, the airbag module comprising:
an inflator having a flange; and
a mounting device comprising a mounting plate and a first retention device disposable to extend from the mounting plate to overlap a straight portion of an outer edge of the flange to grip the flange against the mounting plate, wherein the mounting plate further comprises a second retention device disposed opposite the first retention device with respect to the mounting plate to permit installation of the flange generally between the first and second mounting devices, where in the mounting plate comprises a planar surface.

27. The airbag module of claim 26, wherein the first retention device comprises a clip comprising a shank and a head comprising a retention surface that contacts the flange proximate a straight portion of the outer edge, wherein the first retention device is deformable to permit flexure of the first retention device.

28. The airbag module of claim 26, wherein the mounting device further comprises two rigid retainers disposed to slidably receive the inflator, wherein the first retention device acts to prevent nondestructive sliding removal of the inflator from the rigid retainers.

29. A method for assembling an airbag module for protecting an occupant of a vehicle from impact, the airbag module comprising an inflator having a flange and a mounting device comprising a retention device integrally formed with a mounting plate, the method comprising:
aligning the inflator with the mounting plate;
actuating the inflator toward the mounting plate to induce the retention device to flex from a natural configuration to receive the flange; and
further actuating the inflator toward the mounting plate to secure the inflator against the mounting plate by permitting motion of the retention device back towards the natural configuration.

30. The method of claim 29, wherein the retention device comprises a snap, wherein aligning the inflator with the mounting plate further comprises aligning the snap with a hole formed in the flange.

31. The method of claim 29, wherein the retention device comprises a clip, wherein aligning the inflator with the mounting plate further comprises aligning the clip with a straight portion of an outer edge of the flange.

32. The method of claim 29, wherein the mounting device further comprises rigid retainer comprising a retainer surface, wherein aligning the inflator with the mounting plate further comprises disposing the flange between the retainer surface and the mounting plate of the mounting device.

33. A method of assembling an airbag module for protecting an occupant of a vehicle from impact, the airbag module comprising an inflator having a flange comprising an outer edge having a straight portion, and a mounting device comprising a first and a second retention device extending from a mounting plate, the method comprising:
aligning a straight outer edge of the flange with the first and second retention devices and the mounting plate; and
disposing the straight outer edge, the first and second retention device, and the mounting plate such that the first and second retention devices overlap a straight portion of the outer edge to grip the flange against the mounting plate.

34. The method of claim 33, wherein disposing the straight outer edge, the retention device, and the mounting plate comprises flexing the first and second retention devices from a natural configuration to receive the flange and moving back towards a natural configuration to grip the flange against the mounting plate in a manner that resists nondestructive disassembly.

35. The method of claim 33, wherein the mounting device comprises a third retention device, wherein the first and second retention devices comprise two rigid retainers integrally formed with the mounting plate, wherein the mounting plate comprises a planar surface, wherein disposing the straight portion of the outer edge, the first and second retention devices, and the mounting plate such that the retention devices overlap the straight portion comprise:
sliding the flange between two rigid retainers such that the flange is disposed between a contact surface of each rigid retainer and the mounting plate to induce flexure of the third retention device; and
moving the retention device back towards the natural configuration to resist nondestructive disassembly of the inflator and the mounting device.
